(19) United States
(12) Patent Application Publication
(10) Pub. No.: US 2002/0002507 A1
(43) Pub. Date: Jan. 3, 2002

(54) Simple payment system and method for merchandise purchased by mobile telephone terminal

(75) Inventor: Koichi Hatakeyama, Tokyo (JP)

Correspondence Address: SUGHRUE, MION, ZINN,, MACPEAK & SEAS, 2100 Pennsylvania Avenue, N.W., Washington, DC, 20037, US

(73) Assignee: NEC CORPORATION

(21) Appl. No.: 09/891,247

(22) Filed: Jun. 27, 2001

(30) Foreign Application Priority Data
Jun. 28, 2000 (JP) 193647/2000

(51) Int. Cl. G06F 17/60

(52) U.S. Cl. 705/26

(57) ABSTRACT

A simple payment system and method for merchandise purchased by a mobile telephone terminal, in which an on-line shopping is executed without executing the complex operation of a PC and a payment for the purchased merchandise is simplified, is provided. When a mobile telephone terminal made access to a Web site for the on-line shopping, merchandise information is displayed on a displaying section of the mobile telephone terminal. When a user chose desiring merchandise based on the merchandise information displayed on the displaying section, a message, which instructs the user to insert a prepaid card or a debit card into a slot of the card reader and to input a password of the user to the mobile telephone terminal, is displayed on the displaying section. When the user inserted the prepaid card or the debit card and inputted the password, the information of the card and the password is transmitted to the server. The server confirms the information and authenticates the information. When the information was authenticated, the merchandise is delivered to the address registered beforehand from a delivery center by an instruction from the server. At the same time, the server subtracts the amount of the merchandise from the prepaid card or the bank account of the debit card.

### BACKGROUND OF THE INVENTION

The present invention relates to a simple payment system and method for merchandise purchased by a mobile telephone terminal, in particular, at an on-line shopping.

### DESCRIPTION OF THE RELATED ART

Recently, image data have been able to be displayed precisely on a displaying screen of a mobile telephone terminal by that a liquid crystal display (LCD) has been large sized and colored.

Furthermore, by using the large sized and colored LCD, it has been possible that a user of a mobile telephone terminal browses through Web sites by utilizing world wide web (WWW) at the Internet in addition to that the user makes a telephone call.

The Internet has been able to be used by the mobile telephone terminals and also an on-line shopping by using the Internet has been becoming popular at the mobile telephone terminals. However, the on-line shopping is designed mainly for users of personal computers (PCs), therefore, a user not operating the PC sufficiently can not use the on-line shopping easily by using the mobile telephone terminal.

### SUMMARY OF THE INVENTION

It is therefore an object of the present invention to provide a simple payment system and method for merchandise purchased by a mobile telephone terminal, in which a user of the mobile telephone terminal can use the on-line shopping without executing complex operation of a PC and the payment for the purchased merchandise can be simplified.

According to the present invention, there is provided a simple payment system for merchandise purchased by a mobile telephone terminal. The simple payment system for merchandise purchased by the mobile telephone terminal provides plural mobile telephone terminals that provide a card reader for reading information from a prepaid card in which the payable amount of money is at least registered beforehand and for reading information from a debit card (cash card), and a server for making the mobile telephone terminal, which purchased merchandise by an on-line shopping, pay the amount of the merchandise based on the information read at the card reader.

According to the present invention, there is provided a simple payment method for merchandise purchased by a mobile telephone terminal. And at the simple payment method for merchandise purchased by the mobile telephone terminal, when a mobile telephone terminal, which provides a card reader for reading information from a prepaid card in which the payable amount of money is at least registered beforehand and for reading information from a debit card, made a purchase order for merchandise on an on-line shopping, a server makes the mobile telephone terminal pay the amount of the purchased merchandise based on the information read at the card reader.

According to the present invention, as mentioned above, the simple payment system for merchandise purchased by the mobile telephone terminal provides the card reader that can read information of the prepaid card or the debit card in the mobile telephone terminal, therefore the on-line shopping can be executed easily.

According to the present invention, when a user makes access to Web sites or on-line shopping pages through the Internet from the mobile telephone terminal having a card reader function, merchandise information is downloaded from the Web sites or the on-line shopping pages to the mobile telephone terminal, and the merchandise information is displayed on a displaying section (LCD) of the mobile telephone terminal.

And when the user chose desiring merchandise based on the merchandise information displayed on the LCD, a message, which instructs that the prepaid card or the debit card is read at the card reader and also a password of the user is inputted by using a keyboard composed of such as a ten-key part, is displayed.

And when the information of the prepaid card or the debit card was read and the password was inputted by the message mentioned above, the information and the password are transmitted to the server. And the server confirms the authenticity of the information and the password, and when the authenticity was proved, the server instructs to deliver the merchandise to the address of the user registered beforehand.

By using the structure and the operation mentioned above, the mobile telephone terminal can be used as an input terminal for electronic money attached a password such as a prepaid card and a debit card. With this, the on-line shopping can be executed at the mobile telephone terminal without executing the complex operation at the PC, and also the payment for the merchandise can be executed at the mobile telephone terminal through the server.

And the prepaid card and the debit card are used for the payment for the merchandise, therefore, even when the mobile telephone terminal is lost or stolen, the security can be secured.

Moreover, the merchandise, which is ordered by using the on-line shopping, is delivered to the user address registered beforehand, therefore, the input of the user address can be omitted at the time when the user orders the merchandise by using the on-line shopping. Therefore, it can be avoided that the merchandise is delivered to the other person.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a structure of a simple payment system for merchandise purchased by a mobile telephone terminal at an embodiment of the present invention; and

FIG. 2 is a flowchart showing the operation of the simple payment system for merchandise purchased by the mobile telephone terminal at the embodiment of the present invention.

### DESCRIPTION OF THE PREFERRED EMBODIMENT

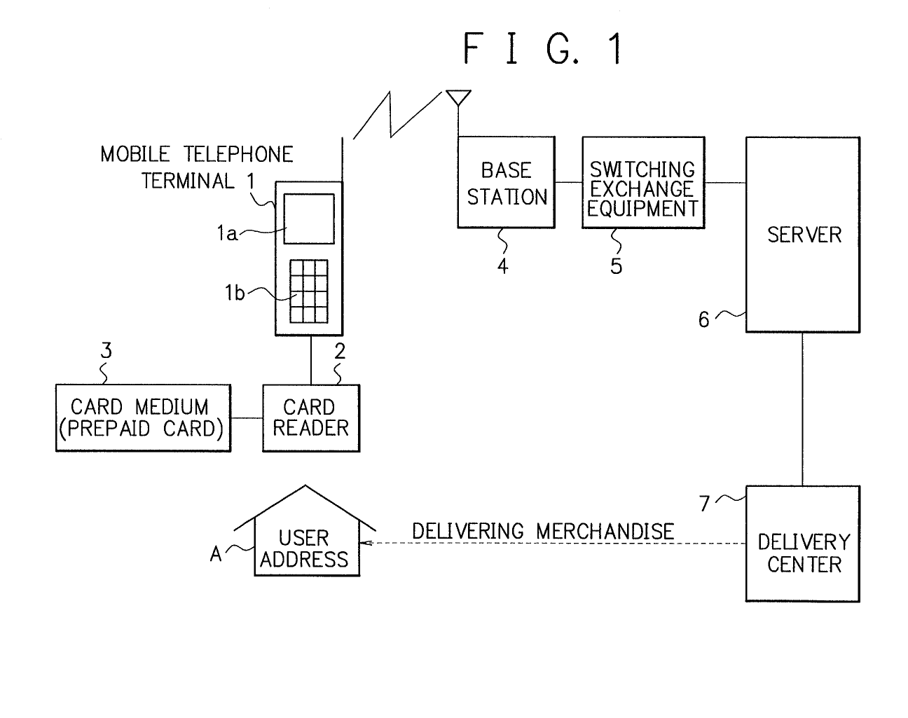

Referring now to the drawings, an embodiment of the present invention is explained in detail. FIG. 1 is a block diagram showing a structure of a simple payment system for merchandise purchased by a mobile telephone terminal at the embodiment of the present invention. As shown in FIG. 1, the simple payment system for merchandise purchased by the mobile telephone terminal at the embodiment of the present invention consists of a mobile telephone terminal 1, a card reader 2 assembled in or connected to the mobile telephone terminal 1, a base station 4, switching exchange equipment 5, a server 6, and a delivery center 7. In this, the number of the mobile telephone terminal 1 is one and the number of the base station 4 is also one, however, actually plural mobile telephone terminals and plural base stations are provided in the system. And also the number of the switching exchange equipment 5, the number of the server 6, and the number of the delivery center 7 is not limited to one each.

The mobile telephone terminal 1 provides a displaying section 1a in which information such as merchandise information and messages is displayed and a keyboard 1b composed of such as a ten-key part (not shown) in which information such as a telephone number of a destination and a password is inputted.

And, the mobile telephone terminal 1 can read information storing in a card medium 3 such as a prepaid card and a debit card by using the card reader 2. The debit card is a bank card (cash card), and after a deal of the merchandise was completed and when a user inserts the debit card in a slot of the card reader 2, the amount of merchandise is automatically drawn form his/her bank account. Furthermore, the mobile telephone terminal 1 can transmit the password of the user inputted from the ten-key part of the keyboard 1b with the card information and the merchandise information chosen by the user.

When the mobile telephone terminal 1 makes access to the server 6 via the base station 4 and the switching exchange equipment 5, the server 6 supplies Web sites and on-line shopping pages storing in the server 6 itself to the mobile telephone terminal 1. The delivery center 7 delivers merchandise ordered by the user to the user address A that is registered beforehand, when the delivery center 7 received a delivery instruction from the server 6.

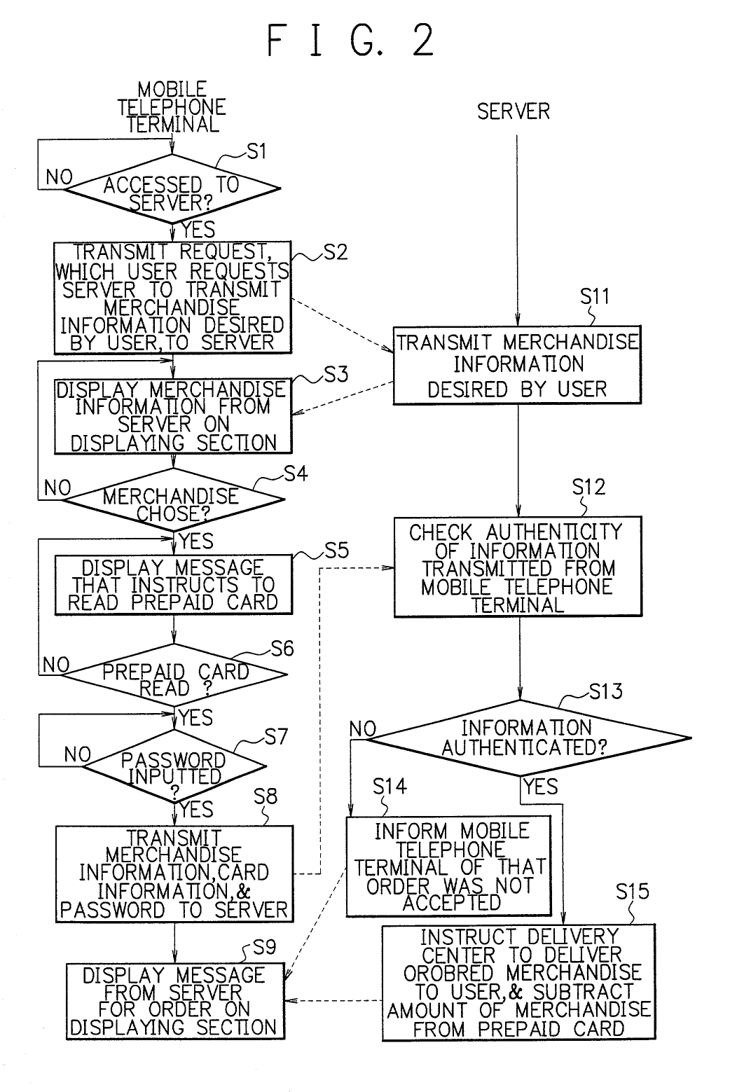

FIG. 2 is a flowchart showing the operation of the simple payment system for merchandise purchased by the mobile telephone terminal at the embodiment of the present invention. Referring to FIGS. 1 and 2, the operation of the embodiment of the simple payment system for merchandise purchased by the mobile telephone terminal of the present invention is explained. In this, a case that a prepaid card is used as the card medium 3 for the payment of merchandise at the on-line shopping is explained. In this explanation, the step number is the step number shown in FIG. 2.

First, the mobile telephone terminal 1 makes access to the server 6 (YES at step S1) and transmits a request, which a user requests the server 6 to transmit merchandise information desired by the user, to the server 6 (step S2). The server 6, received the request, transmits the merchandise information (including image data) desired by the user to the mobile telephone terminal 1 (step S11).

At the mobile telephone terminal 1, the merchandise information transmitted from the server 6 is displayed on the displaying section 1a (step S3). And when the user chose desiring merchandise from the merchandise information displayed on the displaying section 1a (YES at step S4), the mobile telephone terminal 1 displays a message, which instructs the card reader 2 to read the prepaid card 3, on the displaying section 1a (step S5).

The user inserts the prepaid card 3 into the slot of the card reader 2 assembled in or connected to the mobile telephone terminal 1 based on the message, and the information of the prepaid card 3 is read by the card reader 2 (YES at step S6). The mobile telephone terminal 1 displays a message, which instructs the user to input the password of the user by using the ten key part of the keyboard 1b, on the displaying section 1a.

The user inputs the password by using the ten key part of the keyboard 1b (YES at step S7). Then, the mobile telephone terminal 1 transmits the merchandise information chosen by the user, the card information of the prepaid card 3 read at the card reader 2, and the password inputted by the user at the ten key part of the keyboard 1b to the server 6 (step S8).

The server 6 checks the authenticity of the merchandise information, the card information, and the password transmitted from the mobile telephone terminal 1 by comparing with user information registered beforehand (step S12).

When the server 6 judged that the information transmitted from the mobile telephone terminal 1 was right (the information was authenticated) (YES at step S13), the server 6 instructs the delivery center 7 to deliver the merchandise ordered by the user to the user address A, and also subtracts the amount of the merchandise from the prepaid card (step S15). The delivery center 7, received the instruction from the server 6, delivers the merchandise ordered by the user to the user address A registered beforehand.

When the server 6 judged that the information transmitted from the mobile telephone terminal 1 was not right (the information was not authenticated) (NO at the step S13), the server 6 informs the mobile telephone terminal 1 of that the order of the merchandise ordered by the user was not accepted (step 14). The mobile telephone terminal 1, received the message that the merchandise was delivered or the order was not accepted from the server 6, displays the message on the displaying section 1a (step S9).

As mentioned above, the user can easily purchase merchandise by using the on-line shopping by using the mobile telephone terminal 1 without executing complex operation of a PC. And the prepaid card and the debit card are used to pay for the merchandise, therefore, even when the mobile telephone terminal 1 is lost or stolen, the security can be secured.

Moreover, the merchandise, which is ordered by using the on-line shopping, is delivered to the user address A registered beforehand, therefore, the input of the user address A can be omitted at the time when the user orders the merchandise by using the on-line shopping. And also it can be avoided that the merchandise is delivered to the other person. Furthermore, since the card reader 2 is assembled in or connected to the mobile telephone terminal 1, the payment for the merchandise can be executed immediately and does not bother the user.

And at the case that the server 6 is made to be a search Web site, the user can access to the other Web sites, and the number of merchandise that the user can purchase by using the on-line shopping can be increased.

And at the case that plural delivery centers 7 are disposed in different locations and/or are directly disposed in manufactures who manufacture merchandise, the embodiment of the simple payment system for merchandise purchased by the mobile telephone terminal of the present invention can be also applied and the delivery cost is reduced.

As mentioned above, according to the present invention, a card reader, which reads information from a prepaid card in which the payable amount of money is registered beforehand or from a debit card, is assembled in or connected to a mobile telephone terminal. And a server executes the operation of the payment of merchandise ordered at an on-line shopping by the mobile telephone terminal, based on the information read by the card reader. With this, the user can easily purchase the merchandise by using the mobile telephone terminal through the on-line shopping without executing complex operation of a PC, and also the payment for the merchandise can be easily executed at the mobile telephone terminal through the server.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A simple payment system for merchandise purchased by a mobile telephone terminal, comprising:
plural mobile telephone terminals that provide a card reader for reading information from a prepaid card in which the payable amount of money is at least registered beforehand and for reading information from a debit card (cash card); and
a server for making said mobile telephone terminal, which purchased merchandise by an on-line shopping, pay the amount of said merchandise based on the information read at said card reader.

2. A simple payment system for merchandise purchased by a mobile telephone terminal in accordance with claim 1, wherein:
said server transmits merchandise information at said on-line shopping to said mobile telephone terminal by responding to the access form said mobile telephone terminal.

3. A simple payment system for merchandise purchased by a mobile telephone terminal in accordance with claim 1, wherein:
said server compares said information read by said card reader and a password inputted from said mobile telephone terminal with information registered in said server beforehand and confirms the authenticity of said information read by said card reader and said password.

4. A simple payment system for merchandise purchased by a mobile telephone terminal in accordance with claim 1, wherein:
said server instruct to deliver said merchandise ordered by said mobile telephone terminal on said on-line shopping to an address registered beforehand corresponding to said mobile telephone terminal when said server authenticated said information transmitted from said mobile telephone terminal.

5. A simple payment system for merchandise purchased by a mobile telephone terminal in accordance with claim 1, wherein:
said card reader is assembled in said mobile telephone terminal or is connected to said mobile telephone terminal.

6. A simple payment system for merchandise purchased by a mobile telephone terminal, comprising:
plural mobile telephone terminals that provide a card reader for reading information from a prepaid card in which the payable amount of money is at least registered beforehand and for reading information from a debit card;
plural base stations for transmitting/receiving data to and from said plural mobile telephone terminals;
at least one server that connects to said plural base stations via switching exchange equipment, and stores merchandise information for an on-line shopping and each password of each user of said plural mobile telephone terminals and each address corresponding to each user of said plural mobile telephone terminals; and
at least one delivery center that delivers said merchandise ordered by each user of said plural mobile telephone terminals to said address of said user of said mobile telephone terminal by an instruction of said server, wherein:
said mobile telephone terminal transmits a request, which said merchandise information desired by said mobile telephone terminal is transmitted to said mobile telephone terminal, to said server via said base station and said switching exchange equipment, and receives said merchandise information, and said mobile telephone terminal transmits said desired merchandise information and said password and information of said prepaid card or said debit card to said server when said mobile telephone terminal decided to purchase said desired merchandise; and
said server confirms said desired merchandise and said information of said prepaid card or said debit card and said password, and instructs said delivery center to deliver said desired merchandise to said address and subtracts the amount of said merchandise from said prepaid card or the bank account of said debit card, when said information of said prepaid card or said debit card and said password was authenticated.

7. A simple payment system for merchandise purchased by a mobile telephone terminal in accordance with claim 6, wherein:
said card reader is assembled in said mobile telephone terminal or is connected to said mobile telephone terminal.

8. A simple payment method for merchandise purchased by a mobile telephone terminal, wherein:
when a mobile telephone terminal, which provides a card reader for reading information from a prepaid card in which the payable amount of money is at least registered beforehand and for reading information from a debit card, made a purchase order for merchandise on an on-line shopping,
a server makes said mobile telephone terminal pay the amount of said purchased merchandise based on the information read at said card reader.

9. A simple payment method for merchandise purchased by a mobile telephone terminal in accordance with claim 8, wherein:
said server transmits merchandise information at said on-line shopping to said mobile telephone terminal by responding to the access form said mobile telephone terminal.

10. A simple payment method for merchandise purchased by a mobile telephone terminal in accordance with claim 8, wherein:
said server compares said information read by said card reader and a password inputted from said mobile telephone terminal with information registered in said server beforehand and confirms the authenticity of said information read by said card reader and said password.

11. A simple payment method for merchandise purchased by a mobile telephone terminal in accordance with claim 8, wherein:
said server instruct to deliver said merchandise ordered by said mobile telephone terminal on said on-line shopping to an address registered beforehand corresponding to said mobile telephone terminal when said server authenticated said information transmitted from said mobile telephone terminal.

12. A simple payment method for merchandise purchased by a mobile telephone terminal in accordance with claim 8, wherein:
said card reader is assembled in said mobile telephone terminal or is connected to said mobile telephone terminal.

13. A simple payment method for merchandise purchased by a mobile telephone terminal, comprising the steps of:
transmitting a request, which merchandise information desired by a mobile telephone terminal and storing in a server is transmitted from said server to a mobile telephone terminal for an on-line shopping, from said mobile telephone terminal to said server;
receiving said desired merchandise information transmitted from said server at said mobile telephone terminal;
making a purchase order for merchandise desired by said mobile telephone terminal at said mobile telephone terminal;
inserting a prepaid card or a debit card into a slot of a card reader provided in said mobile telephone terminal;
inputting a password of a user who ordered said desired merchandise to said mobile telephone terminal;
transmitting said purchase order, information of said prepaid card or said debit card, and said password to said server from said mobile telephone terminal;
confirming said purchase order and said information of said prepaid card or said debit card at said server, and at the same time comparing said password with a password registered beforehand in said server at said server;
authenticating said purchase order and said information of said prepaid card or said debit card and said password at said server;
instructing to deliver said merchandise to an address registered beforehand corresponding to said password when said server authenticated said information transmitted from said mobile telephone terminal; and
subtracting the amount of said delivered merchandise from said prepaid card or the bank account of said debit card at said server.

14. A simple payment method for merchandise purchased by a mobile telephone terminal in accordance with claim 13, wherein:
said card reader is assembled in said mobile telephone terminal or is connected to said mobile telephone terminal.
